(19) United States
(12) Patent Application Publication
(10) Pub. No.: US 2023/0394397 A1
(43) Pub. Date: Dec. 7, 2023

(54) SYSTEM AND METHOD FOR MONITORING AN UNAVAILABILITY-INTERVAL TYPE TO ADJUST AGENT-SCHEDULE TO BE IN ADHERENCE AND TO BALANCE WORKFORCE, IN A CONTACT-CENTER

(71) Applicant: NICE LTD., Ra'anana (IL)

(72) Inventors: Rajesh GUPTA, Lucknow up (IN); Sanyog MISHRA, Pune (IN); Robert DVORSCAK, JR., Dallas, TX (US)

(21) Appl. No.: 17/833,940

(22) Filed: Jun. 7, 2022

(51) Int. Cl. G06Q 10/06

(52) U.S. Cl. CPC G06Q 10/063116; G06Q 10/063114; G06Q 10/063118

(57) ABSTRACT

A computerized-method for monitoring an unavailability-interval type to adjust agent-schedule to be in adherence and to balance workforce, in a contact-center, is provided herein. The computerized-method includes operating a schedule-adjustment module. The schedule-adjustment module includes operating a rule-engine to carry out a rule, based on an unavailability-interval type for monitoring and a time-threshold; for each agent: (i) checking if the agent is in adherence by retrieving agent-state and comparing it with agent currently scheduled-activity. (ii) when the agent is in adherence, retrieving a scheduled-activity after the time-threshold from current-time to calculate an interval-range when the retrieved scheduled-activity is the same as the unavailability-interval type for monitoring operating an intervals-staffing-evaluation module to find an optimum interval, during the calculated interval-range; (iii) when an optimum interval has been found, sending the agent a notification a suggestion to postpone the next-interval-scheduled activity to the optimum interval and upon approval, adjusting the agent-schedule accordingly.

### TECHNICAL FIELD

The present disclosure relates to the field of data analysis and more specifically to monitoring an unavailability-interval type to adjust agent-schedule to be in adherence and to balance workforce in a contact center.

### BACKGROUND

In contact centers, there may be situations where inbound calls don't adhere to a given schedule of an agent. For example, when a call exceeds the time slot that has been scheduled for it, or when a call is assigned right before a scheduled activity, such as break or lunch. Currently, when such a situation happens, the agent may request for manual adjustment of the schedule, e.g., by marking the status in the system, e.g., Employee Engagement Management (EEM) system, as out of adherence. The consequences of this process of manual adjustment may result with a resource and time-consuming process such as a requirement to explain the cause of the marking of out of adherence to a supervisor or to another staff member, especially in a contact center having thousands of agents.

Sometimes, to avoid the results of the manual adjustment, agents may use other non-available reasons in the schedule, other than out of adherence, i.e., marking other exceptions, such as “system down” or they may spend longer time in After Call Work (ACW) after their last call ends, so they don't have to take another call, when their next scheduled activity is an unavailability-interval type, i.e., an activity where they won't be available, such as break, lunch etc., is scheduled right after.

In overall, this process may cause loss of significant available time, that could be used by the agents to reply to calls and may be directly translated to revenue loss for the organization. Moreover, it may also affect the agent's Key Performance Indicator (KPI) and lead to agent frustration. The agent frustration may be directly linked to a high attrition rate which adds to hiring and training costs.

Since the process of manual exceptions approval, may bear a high operational cost, mainly in contact centers having hundreds or thousands of agents, where the impact of the process of manual exceptions approval may accumulate, there is a need for a technical solution that will provide proactive alerts to the agents at the end of an activity and before the next activity starts, based on an analysis of agents current states, their forecast and their schedule to avoid the consequences of manual adjustment, as described above.

Moreover, when the next scheduled activity is break or lunch, i.e., an activity that the agent is not available to receive calls, it may be beneficial to have a technical solution that will identify this situation and postpone agent break in which the agent is not available to receive calls, if the contact center is predicted to be overstaffed in another time slot, which the agent may take the unavailability-interval type then.

Accordingly, there is a need for a method and system for monitoring an unavailability-interval type to adjust agent-schedule to be in adherence and to balance workforce during the agent scheduled shift.

### SUMMARY

There is thus provided, in accordance with some embodiments of the present disclosure, a computerized-method for monitoring an unavailability-interval type to adjust agent-schedule to be in adherence and to balance workforce, in a contact-center.

Furthermore, in accordance with some embodiments of the present disclosure, in a computerized system that includes one or more processors, an Automatic Call Distribution (ACD) system, an agents-schedule cache, and Employee Engagement Manager (EEM) application, the one or more processors may be configured to operate a schedule-adjustment module.

Furthermore, in accordance with some embodiments of the present disclosure, the schedule-adjustment module may include a. operating a rule engine in the EEM application to carry out a rule, based on parameters of the rule. The parameters of the rule may be an unavailability-interval type for monitoring and a time-threshold. Then, for each agent in the agents-schedule cache the schedule-adjustment module may check if the agent is in adherence by retrieving agent-state from the ACD system and comparing the agent-state with agent currently scheduled-activity in the agents-schedule cache.

Furthermore, in accordance with some embodiments of the present disclosure, when the agent-state is compatible with the agent currently scheduled-activity in the agents-schedule cache the agent may be determined as in adherence. When the agent is in adherence, the schedule-adjustment module may retrieve, from the agents-schedule cache, a scheduled-activity after the time-threshold from current-time. The retrieved scheduled-activity may be determined as next-interval-scheduled activity, when the retrieved-scheduled activity is different than the currently scheduled-activity.

Furthermore, in accordance with some embodiments of the present disclosure, when the next-interval-scheduled activity may be same as the unavailability-interval type for monitoring, the schedule-adjustment module may calculate an interval-range. Then, the schedule-adjustment module may operate an intervals-staffing-evaluation module to find an optimum interval, during the calculated interval-range. The optimum interval may be an interval that is overstaffed and having a highest staffing gap between scheduled staff and required staff than other overstaffed intervals in the calculated interval-range.

Furthermore, in accordance with some embodiments of the present disclosure, when an optimum interval has been found, the schedule-adjustment module may send a notification to a computerized-device of the agent with a suggestion to postpone the next-interval-scheduled activity to the optimum interval and upon receiving an approval from the agent, the schedule-adjustment module may adjust the agent-schedule accordingly.

Furthermore, in accordance with some embodiments of the present disclosure, schedules of each agent in the agents-schedule cache may be synchronized every preconfigured interval with a Workforce Management (WFM) system.

Furthermore, in accordance with some embodiments of the present disclosure, the unavailability-interval may be selected from at least one of: break, lunch, meeting, coaching, back office, or any other activity.

Furthermore, in accordance with some embodiments of the present disclosure, the calculating of the interval range may be based on work-rules related to the unavailability-interval type.

Furthermore, in accordance with some embodiments of the present disclosure, the adjusting of the agent-schedule may be operated by updating the agent-schedule in the agents-schedule cache with the next-interval-scheduled activity in the optimum interval.

Furthermore, in accordance with some embodiments of the present disclosure, when no optimum interval has been found, then the schedule-adjustment module may send a notification to a computerized-device of the agent with a suggestion to conclude current activity within a predefined threshold and to precede the next-interval-scheduled activity to current-time and upon receiving an approval from the agent, the schedule-adjustment module may adjust the agent-schedule based on the time that the agent moved to the next-interval-scheduled activity.

Furthermore, in accordance with some embodiments of the present disclosure, the adjusting of the agent-schedule may be operated by updating the agent-schedule in the agents-schedule cache with the next-interval-scheduled activity starting in the current-time.

Furthermore, in accordance with some embodiments of the present disclosure, when the agent is not in adherence-state and the agent-state is on-call and the agent currently scheduled-activity in the agents-schedule cache is an unavailability-interval type automatically, the schedule-adjustment module may adjust the agent schedule.

Furthermore, in accordance with some embodiments of the present disclosure, the adjusting of the agent-schedule may be operated by updating the agent-schedule in the agents-schedule cache when agent-state retrieved from the ACD system changes accordingly.

Furthermore, in accordance with some embodiments of the present disclosure, after the adjusting of the agent-schedule sending a notification to the computerized-device of the agent as to the schedule adjustment.

There is further provided, in accordance with some embodiments of the present disclosure, a computerized-system for monitoring an unavailability-interval type to adjust agent-schedule to be in adherence and to balance workforce, in a contact-center.

Furthermore, in accordance with some embodiments of the present disclosure, the computerized-system may include one or more processors, an Automatic Call Distribution (ACD) system, an agents-schedule cache, and an Employee Engagement Manager (EEM) application.

Furthermore, in accordance with some embodiments of the present disclosure, the one or more processors may be configured to operate a schedule-adjustment module as described above.

### BRIEF DESCRIPTION OF THE DRAWINGS

FIG. 1 schematically illustrates a high-level diagram of a system for monitoring an unavailability-interval type to adjust agent-schedule to be in adherence and to balance workforce, in a contact-center, in accordance with some embodiments of the present disclosure;

FIG. 2 is a high-level workflow of monitoring an unavailability-interval type to adjust agent-schedule to be in adherence and to balance workforce, in accordance with some embodiments of the present disclosure;

FIGS. 3A-3B are an example of a computerized-method of monitoring an unavailability-interval type to adjust agent-schedule to be in adherence and to balance workforce, in accordance with some embodiments of the present disclosure;

FIGS. 4A-4B are a high-level workflow of a schedule-adjustment module, in accordance with some embodiments of the present disclosure;

FIGS. 5A-5B are screenshots depicting a user interface to configure monitoring an unavailability-interval type to adjust agent-schedule to be in adherence and to balance workforce, in accordance with some embodiments of the present disclosure;

FIG. 6. is a screenshot of agent schedule in EEM application, in accordance with some embodiments of the present disclosure; and

FIGS. 7A-7C are screenshots depicting a notification to an agent with a suggestion to precede the next-interval-scheduled activity to current-time, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “in adherence” as used herein refers to an alignment of current agent activity with agent scheduled activity as set in the Workforce Management (WFM) system.

A scheduled shift of an agent in a contact center may be comprised of several time slots. For example, a scheduled shift may start at 8:00 AM and end at 5:00 PM. It may be determined that from 8:00 AM through 9:30 AM the agent will have open time in which the agent may be available to receive inbound-interactions. Then, from 9:30 AM through 9:45 AM a break. From 9:45 AM through 12:00 PM the agent may have open time in which the agent may be available to receive inbound-interactions. Then, from 12:00 PM through 12:30 lunch. From 3:00 PM through 3:15 PM the agent will have a second break and then from 3:15 PM through 5:00 PM the agent may have open time in which the agent may be available to received inbound-interactions.

In current solutions, when an agent receives an inbound-call at 9:26 AM just before the end of ‘open time’ and the beginning of a break, the agent may end the call at 9:32 AM, and therefore may be marked as out of adherence in the system, which may later on require interacting with a supervisor for allowance of the exception and for a manual schedule adjustment.

Current solutions in contact centers merely provide an alert to agents for activity start or activity end. There may be a high operational cost for a process of manual exceptions approval. Accordingly, there is a need for a technical solution that will provide proactive alerts to the agents at the end of an activity and before the next activity starts, based on an analysis of agents current states, staff forecast and their schedule, to avoid the consequences of manual adjustment and squandering of resources.

Moreover, when the next scheduled activity is an unavailability-interval type, it may be beneficial to have a technical solution that will identify that situation and postpone the next activity in which the agent is not available to receive calls, if the contact center is predicted to be overstaffed in another time slot, which then the agent may take the unavailability-interval type.

Furthermore, there is a need for a method and system for monitoring an unavailability-interval type to adjust agent-schedule to be in adherence and to balance workforce during the agent scheduled shift.

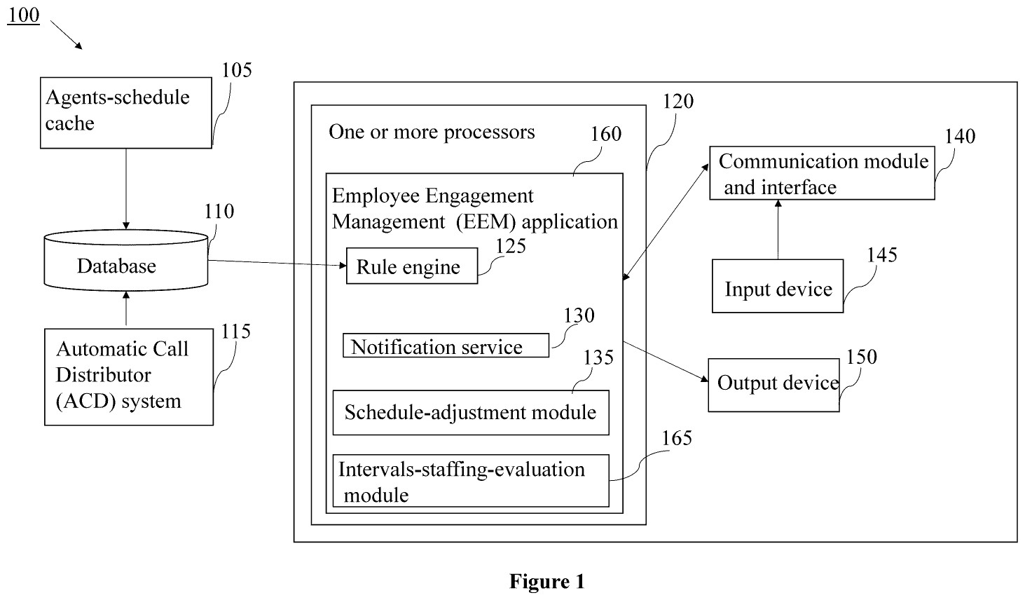

FIG. 1 schematically illustrates a high-level diagram of a system 100 for monitoring an unavailability-interval type to adjust agent-schedule to be in adherence and to balance workforce, in a contact-center, in accordance with some embodiments of the present disclosure.

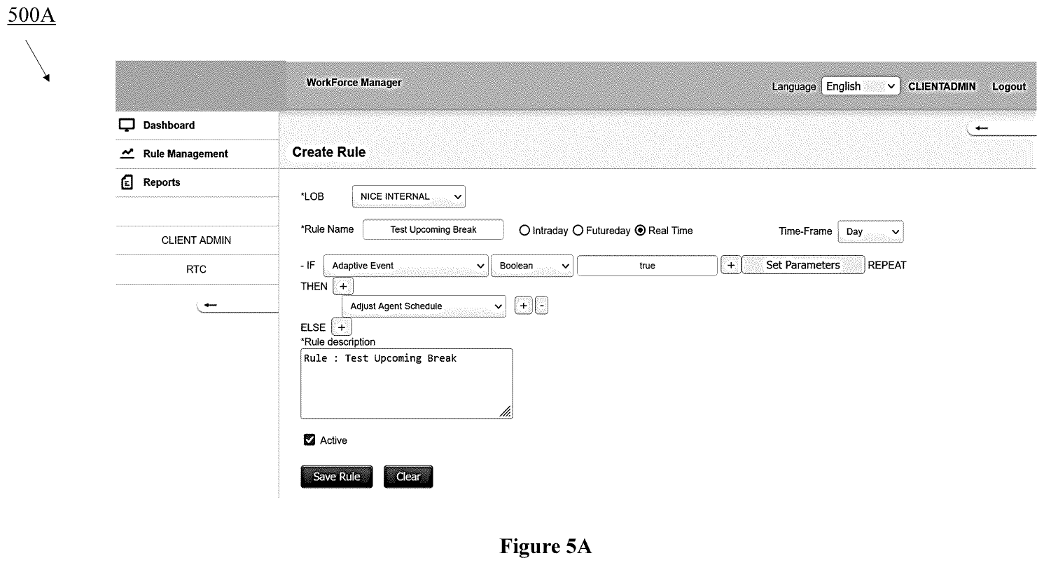

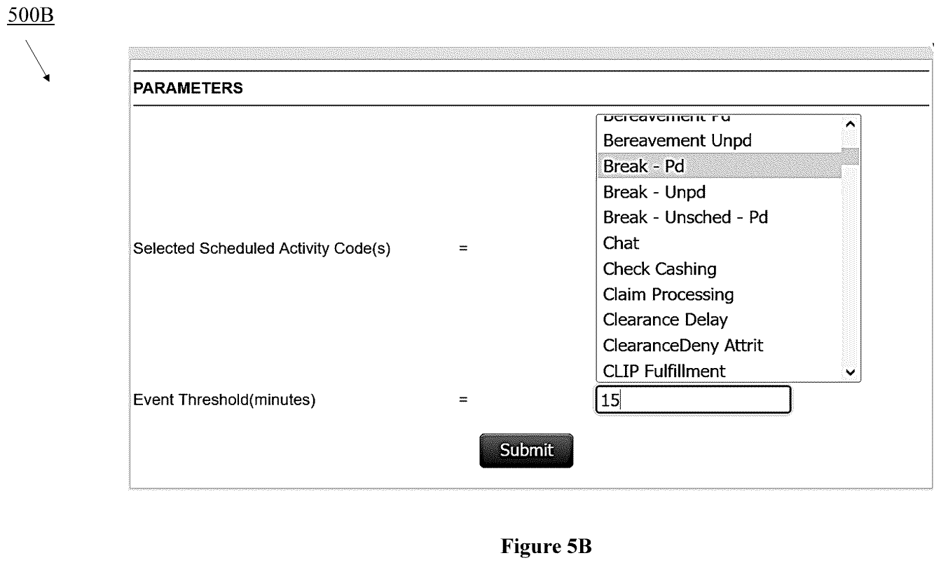

According to some embodiments of the present disclosure, a system, such as system 100, may include one or more processors 120, Automatic Call Distribution (ACD) system 115, an agents-schedule cache 105, and Employee Engagement Manager (EEM) application 160. The one or more processors 120 may be configured to operate a module, such as schedule-adjustment module 135 and such as schedule-adjustment module 500 in FIG. 5.

According to some embodiments of the present disclosure, the schedule-adjustment module 135 may include operating a rule engine 125 in the EEM application 160 to carry out a rule, based on parameters of the rule. The parameters of the rule may be an unavailability-interval type for monitoring and a time-threshold. For example, the unavailability-interval type may be break or pause and the time-threshold may be 15 minutes, as shown in Graphical User Interface (GUI) 500B in FIG. 5.

According to some embodiments of the present disclosure, for each agent in the agents-schedule cache 105, the schedule-adjustment module 135 may include checking if the agent is in adherence, by retrieving agent-state from the ACD system 115 and comparing the retrieved agent-state with agent currently scheduled-activity in the agents-schedule cache 105. When the agent-state is compatible with the agent currently scheduled-activity in the agents-schedule cache 105, the agent may be determined as in adherence. For example, ‘open’ state in an agent schedule in WFM system, may be mapped to “on-call”, “ready”, “ACW”, Break, Lunch agent scheduled activities can be similarly mapped to “Break”, “Lunch” states in the ACD system 115.

According to some embodiments of the present disclosure, the retrieved agent-state from the ACD system 115 and the agent currently scheduled-activity in the agents-schedule cache 105 may be stored in a database, such as database 110.

According to some embodiments of the present disclosure, the ACD system 115, may have Auxiliary (AUX) codes, i.e., reason codes, such as AUX1=‘break’, AUX2=‘system down’ and the like, which are used to track the time that an agent in the contact center has deliberately chosen to not accept calls distributed by the ACD system 115. The AUX may be retrieved from the ACD system 115 to be mapped with an activity of the agent as stored in the agents-schedule cache 105. The agent may move to ready or available state as soon as they login to the ACD system 115 and will remain on that state until the agent selects any aux state or receives an inbound call.

According to some embodiments of the present disclosure, activities may be categorized as ‘ready to handle a call’ or ‘not-ready to receive a call’. To move from one state to another the agents have to select various options via their softphone or physical device, to report to the ACD system 115 in what state they are in. For example, after the agent ends a received call and hangs up, the agent may select an indication of After Call Work (ACW) state and then the agent has to select again an indication that the agent is ready to receive calls or in an unavailability-interval type, such as break.

According to some embodiments of the present disclosure, when the agent is in adherence, the schedule-adjustment module 135 may further include retrieving a scheduled-activity after the time-threshold from current-time, from the agents-schedule cache 105. The retrieved scheduled-activity may be determined as next-interval-scheduled activity when the retrieved-scheduled activity is different than the currently scheduled-activity.

According to some embodiments of the present disclosure, when the next-interval-scheduled activity is same as the unavailability-interval type for monitoring, the schedule-adjustment module 135 may further include calculating an interval-range.

According to some embodiments of the present disclosure, the schedule-adjustment module 135 may further include operating a module, such as intervals-staffing-evaluation module 165 to find an optimum interval, during the calculated interval-range. The optimum interval is an interval that is overstaffed and having a highest staffing gap between the scheduled staff and the required staff than other overstaffed intervals during the calculated interval-range.

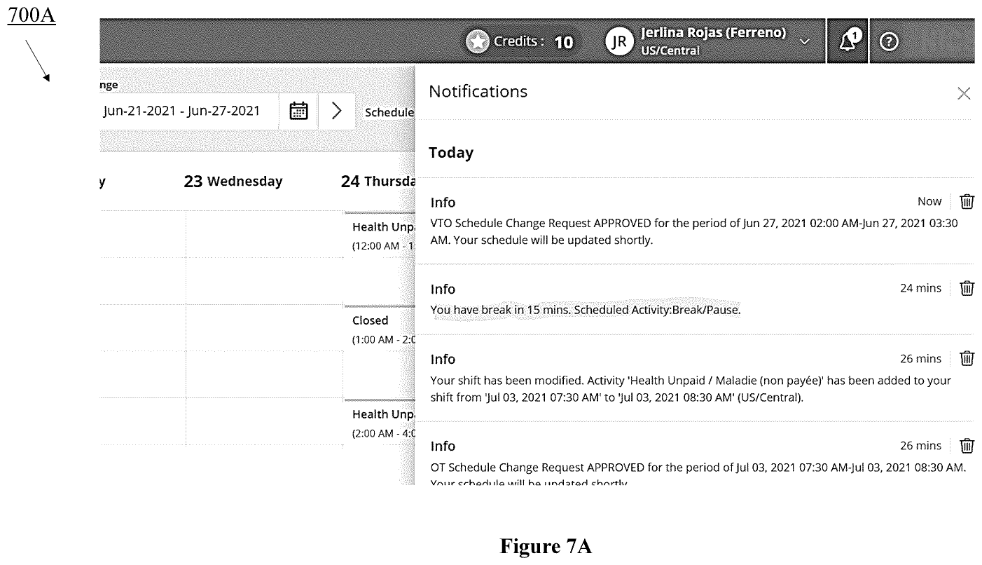

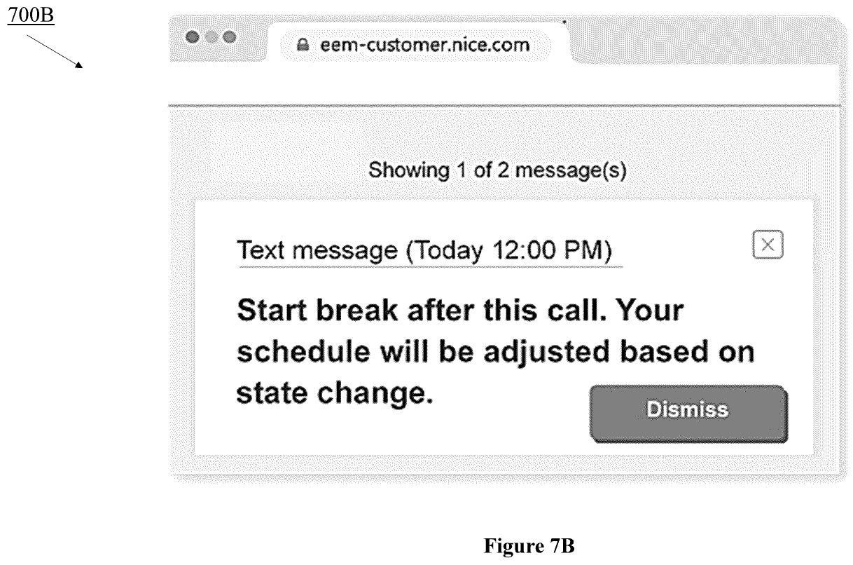

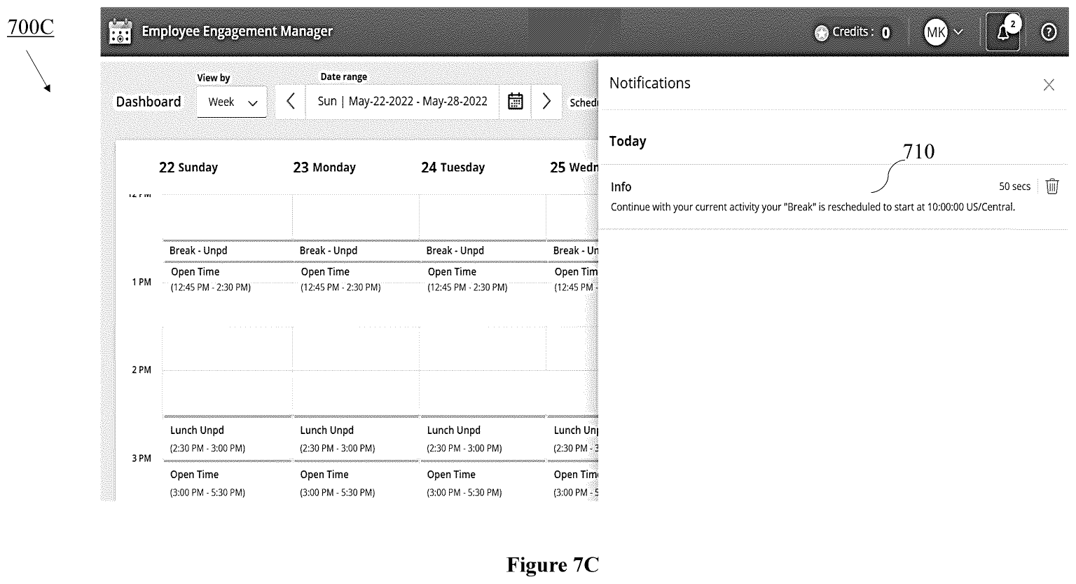

According to some embodiments of the present disclosure, when an optimum interval has been found, by the intervals-staffing-evaluation module 165, during the calculated interval-range, the schedule-adjustment module 135 may further include sending a notification to an output device 150, such as a computerized-device of the agent to be presented via a GUI of an application, such as EEM application. The presented notification may include a suggestion to postpone the next-interval-scheduled activity to the optimum interval and upon receiving an approval from the agent, for the suggested postponement, adjusting the agent-schedule accordingly. For example, notification 710 as shown in screenshot 700C in FIG. 7C.

According to some embodiments of the present disclosure, schedules of each agent in the agents-schedule cache 105 may be synchronized every preconfigured interval with a Workforce Management (WFM) system via an Employee Engagement Manager (EEM) system.

According to some embodiments of the present disclosure, the unavailability-interval type may be selected from at least one of: ‘break’, ‘lunch’, ‘meeting’, ‘coaching’, ‘back office’ or any other activity. For example, as shown by Graphical User Interface (GUI) 500B in FIG. 5B.

According to some embodiments of the present disclosure, the calculating of the interval range may be based on work-rules related to the unavailability-interval type. For example, work-rules may be first break start time should be between 1-3 hours from the shift start time. Another example of a work-rule may be the difference between two breaks should be 4 hours. Accordingly, for example, the calculating of the interval range may be based on work-rules related to the unavailability-interval type and checking when a break may be postponed, that is, if the agent shift start time is at 10:00 AM, then the first break may start the latest by 1:00 PM.

According to some embodiments of the present disclosure, the adjusting of the agent-schedule may be operated by updating the agent-schedule in the agents-schedule cache 105 with the next-interval-scheduled activity in the optimum interval.

According to some embodiments of the present disclosure, when no optimum interval has been found then the schedule-adjustment module 135 may further include sending a notification to an output device 150 such as a computerized-device of the agent with a suggestion to conclude current activity, such as ‘on-call’ or ‘ACW’, within a predefined threshold and to precede the next-interval-scheduled activity to current-time and upon receiving an approval from the agent, the schedule-adjustment module 135 may further include adjusting the agent-schedule based on the time that the agent has moved to the next-interval-scheduled activity. For example, the agent selects a related aux state such as ‘break’ to move to the next activity.

According to some embodiments of the present disclosure, the adjusting of the agent-schedule may be operated by updating the agent-schedule in the agents-schedule cache 105 with the next-interval-scheduled activity starting in the current-time.

According to some embodiments of the present disclosure, when the agent is not in adherence-state and the agent-state is ‘on-call’ and the agent currently scheduled-activity in the agents-schedule cache 105 may be an unavailability-interval type, such as ‘break’ or ‘lunch’, the schedule-adjustment module 135 may further include automatically adjusting the agent schedule in the WFM system.

According to some embodiments of the present disclosure, after the adjusting of the agent-schedule the schedule-adjustment module 135 may further include sending a notification to an output device 150, such as, the computerized-device of the agent as to the schedule adjustment to be presented via a GUI of an application such as an EEM application 160.

According to some embodiments of the present disclosure, a system, such as system 100 in FIG. 1, may operate a schedule-adjustment module 135 update the agent schedule in one of the following cases: (i) when the agent moves to next activity state after receiving a notification and before scheduled start time of the next activity. Accordingly, an auto adjustment may be made to the agent actual start time on the agent-schedule; (ii) when the agent moves to the next activity after the scheduled time of the next activity but within the defined threshold, in the rule in the rule engine 125.

Accordingly, an auto adjustment may be made to agent actual start time of the next activity on the schedule; and (iii) when agents move to next activity after the predefined threshold time in the rule in the rule engine 125. Accordingly, an auto adjustment may be made to the agent actual start time of the next activity on the schedule and make threshold end time as the agent new activity scheduled time.

For example, when the agent doesn't end the current activity withing the predefined threshold time limit then system 100 may forcefully adjust the agent schedule, such as at 10:25 the agent may receive a notification that the agent should end the call by 10:30 i.e., minutes threshold time. When the agent continues beyond the 10:30 interval, then system 100 may modify the agent schedule e.g., break start time from 10:30 through 10:45 and the agent may be marked as out of adherence in such cases.

According to some embodiments of the present disclosure, notifications sent to the agents may be operated by a notification service 130 which may be associated to a communication module and interface 140. The rules in the rule engine 125 may be configured via the communication module and interface 140, from an input device 145, as shown in FIGS. 5A-5B.

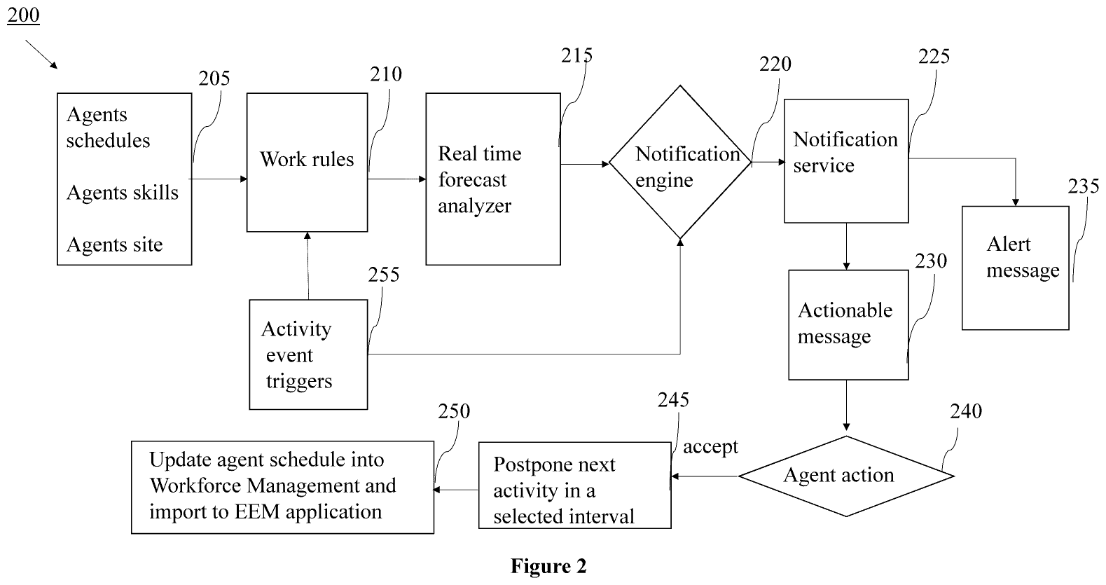

FIG. 2 is a high-level workflow 200 of monitoring an unavailability-interval type to adjust agent-schedule to be in adherence and to balance workforce, in accordance with some embodiments of the present disclosure.

According to some embodiments of the present disclosure, agents schedule which is the activity that the agent will be working during a shift, agent skills and agent site 205 may be provided to the schedule-adjustment module 135 in FIG. 1, so that the schedule-adjustment module 135 in FIG. 1 may operate on agents schedules of agents having the same skills and from the same site and time zone.

According to some embodiments of the present disclosure, once an activity event trigger 225 which is a predefined trigger time which may be reached a real time forecast analyzer 215 may find an optimum interval to move the agent next activity and the agent may be sent a notification about next upcoming activity and instructions to go to next state as per the available interval or as soon as current work is completed and the agent schedule may be automatically adjusted, as shown in screenshot 700B in FIG. 7B.

According to some embodiments of the present disclosure, a rule engine in an EEM application, such as rule engine 125, may be operated in the background to carry out a rule, based on parameters of the rule. The rule may be configured to monitor an activity, e.g., unavailability-interval type, such as ‘break’ and ‘lunch’ activity for adherence assistance and advance notification, along with a threshold value, as shown in GUI 500B in FIG. 5B.

According to some embodiments of the present disclosure, the rule may run in the background and may check agent ACD feed for current activity, e.g., agent state, to match it with the scheduled activity in a schedule cache, e.g., an in-memory data structure, such as agents-schedule cache 105 in FIG. 1, which is synced with a Workforce Management (WFM) system on a predefined interval via an Employee Engagement Manager (EEM) system.

According to some embodiments of the present disclosure, a component, such as activity event triggers 255 may communicate with an ACD interface to continuously check for each agent in the schedule cache, such as agents-schedule cache 105 in FIG. 1, for the unavailability-interval type in the rule. Once the activity event triggers 255 starts polling for agents state events from the ACD system, for a given agent, it may match the agent state, e.g., ‘on call’ with the agent scheduled activity in the schedule cache which is synced with the WFM system via an EEM system.

According to some embodiments of the present disclosure, a scheduled-activity after the time-threshold from current-time, may be retrieved from the schedule cache. The retrieved scheduled-activity may be determined as next-interval-scheduled activity when the retrieved-scheduled activity is different than the currently scheduled-activity. The time-threshold as defined in the rule determines how much to look in future to see the difference in the current activity vs. the scheduled activity.

According to some embodiments of the present disclosure, when the time-threshold is set to 15 minutes and the current time is 11:00 AM and the retrieved agent-state from the ACD system is “on call”, which is mapped to agent schedule “open” in the WFM system, and the monitored activity is the activity of unavailability-interval type that has to adjust the agent schedule for agent adherence, e.g., break, then the activity that has been scheduled for next interval may be checked based on the following formula:

Next interval=current time+threshold time=11:00:00+00:15:00=11:15:00.

According to some embodiments of the present disclosure, a polling process by which the in-memory data structure i.e., the schedule cache, may be queried for a record for this agent schedule for a given interval may be operated. If there is a record then the next scheduled activity may be returned, if there is no record of the agent schedule in the schedule queue then the Relational Database Management System (RDBMS) may be queried to get the record. The WFM system is a source of the agent schedule, and data may flow from the WFM system to the EEM and from the EEM to the real time schedule cache, such as agents-schedule cache 105 in FIG. 1.

According to some embodiments of the present disclosure, when the agent current scheduled activity is the same as the next activity, a module, such as schedule-adjustment module 135, may keep the polling process for the agent activity. Otherwise, when the agent next activity is the same as the monitored activity, e.g., the unavailability-interval type, then the schedule-adjustment module 135 may include operating a real time forecast analyzer 215 by operating an intervals-staffing-evaluation module, such as an intervals-staffing-evaluation module 165 in FIG. 1, to find an optimum interval, during the calculated interval-range. The optimum interval is an interval that is overstaffed and has a highest staffing gap between scheduled staff and required staff than other overstaffed intervals in the calculated interval-range. To define the range of the adjustment of the agent schedule, so as to bound the changes to avoid violation of work-rules, the calculating of the interval range is based on work-rules which are related to the unavailability-interval type.

According to some embodiments of the present disclosure, the work rules may be stored in the RDBMS and may be based on work rule definitions. For example, the first break of an agent in each shift should be between 3-5 hours of the shift start, the second break should be at least 2 hours away from first break. Similar rules may be defined for other unavailability-interval types like lunch etc.

According to some embodiments of the present disclosure, the calculated interval range which is based on work-rules related to the unavailability-interval type is the time range for the changes in the agent schedule. The intervals-staffing-evaluation module 165 in FIG. 1 may find an optimum interval, during the calculated interval-range, which is the best fit interval for the monitored activity.

According to some embodiments of the present disclosure, the real time forecast analyzer 215 may find staffing gaps between scheduled staff and required staff and based on this it may find intervals which are overstaffed or understaffed. Then, once all the intervals are marked as overstaffed or understaffed, the best fit interval which may be the maximum overstaffed interval, to move the next activity, may be determined within the time range, e.g., interval-range.

According to some embodiments of the present disclosure, the maximum overstaffed interval may be found so that the forecast may be normalized by removing the next activity, i.e., the next activity, which is the monitored activity, e.g., break to the maximum overstaffed interval, thus increasing the occupancy and optimizing the unavailability-interval type position while maintaining the work rule policies.

According to some embodiments of the present disclosure, when an optimum interval has been found, the schedule-adjustment module 135 in FIG. 1, may include sending a notification via a notification engine 220 which provides a notification service 225 to a computerized-device of the agent with an actionable message 230, such as a suggestion to postpone the next-interval-scheduled activity to the optimum interval and upon receiving an approval from the agent, adjusting the agent-schedule accordingly. When no best fit interval has been found then an alert message 235 may be sent to the agent in which the agent may be notified to go to next activity as soon as possible to avoid an adherence violation the schedule-adjustment module 135 in FIG. 1 may adjust the agent schedule based on the new agent state if it is withing the defined time range.

According to some embodiments of the present disclosure, upon the agent action 240 of moving to next state, e.g., ACD state move to out of adherence, the schedule-adjustment module 135 in FIG. 1, may update a writeback service with the exact time when this state was started. Based on the agent action 240, the writeback services may update the WFM system and import to an agent-schedule cache which is associated with the EEM application 250, and the agent-schedule may move to in adherence state.

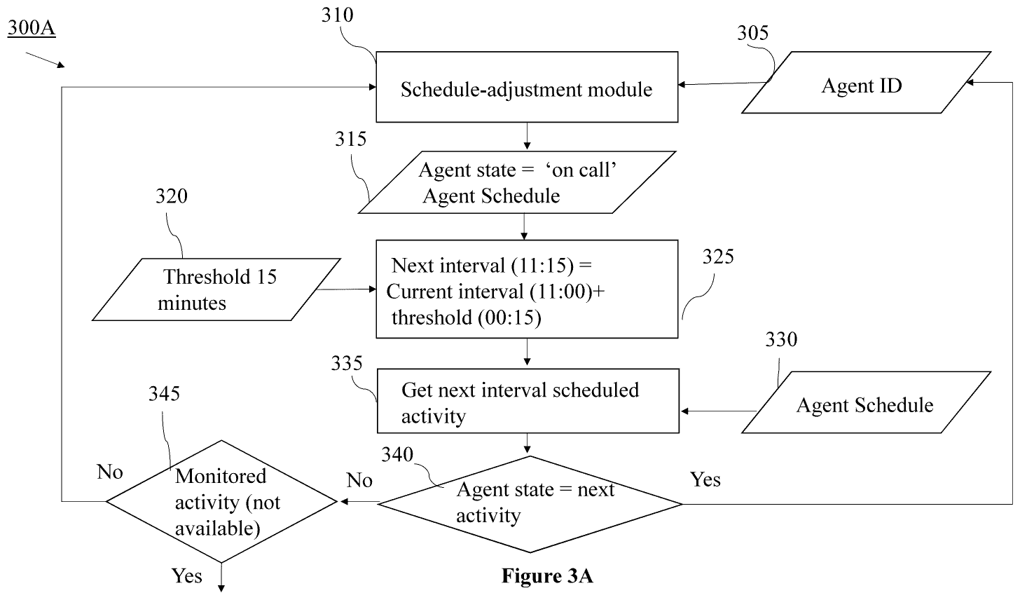

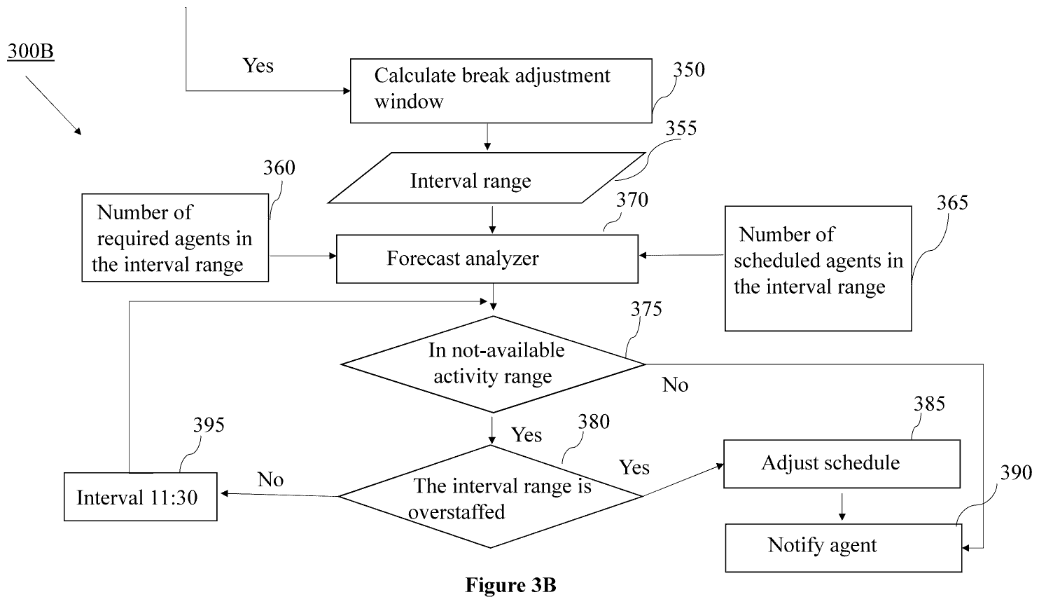

FIGS. 3A-3B are an example of a computerized-method of monitoring an unavailability-interval type to adjust agent-schedule to be in adherence and to balance workforce 300, in accordance with some embodiments of the present disclosure.

According to some embodiments of the present disclosure, a module, such as schedule-adjustment module 310 and such as schedule-adjustment module 135 in FIG. 1, may communicate with an interface of an ACD system to operate a polling process by continuously check for each agent in a schedule cache if the agent next activity is an unavailability-interval type as configured in a rule in the engine rule, such as rule engine 125. The rule may be configured via EEM rule authoring and EEM real time rule processor.

According to some embodiments of the present disclosure, the schedule-adjustment module 310 may start polling for agents state events from the ACD system. The schedule-adjustment module 310 may check if an agent with an agent ID 305 has a match between the agent state e.g., ‘on call’ 315 and the agent current scheduled activity in IEX WFM, that is imported to and saved in an in-memory data structure, such as agents-schedule cache 105 in FIG. 1.

According to some embodiments of the present disclosure, the schedule-adjustment module 310 may retrieve a scheduled-activity after a time-threshold from current-time, from the agents-schedule cache. The retrieved scheduled-activity may be determined as next-interval-scheduled activity when the retrieved-scheduled activity is different than the currently scheduled-activity. The time-threshold is defined in the rule in the rule engine.

According to some embodiments of the present disclosure, the time-threshold may define how much time to look ahead for the next scheduled activity. For example, when the threshold is 00:15 minutes 320 and the current interval is 11:00 then, the next interval is 11:15, as detailed in element 325. The schedule-adjustment module 310 may retrieve the next scheduled activity 335 from the agent schedule 330 that may be maintained in a schedule queue, such as agent-schedule cache 105, which starts at 11:15. The schedule queue may be synced with the WFM system via Employee Engagement Manager (EEM) system that has generated the agents schedules. If the agent schedule is not in the schedule queue, the schedule-adjustment module 310 may retrieve the agent schedule from the RDBMS. For example, an agent ACD state may be “on call”, which may be mapped to agent schedule “open”.

According to some embodiments of the present disclosure, the schedule-adjustment module 310 may compare the agent current state to the agent next scheduled activity and when it is the same the polling process may continue. When it is not the same and the next activity is a monitored activity, as configured in the rule, e.g., unavailability-interval type, 345 in the rule engine, then the schedule-adjustment module 310 may calculate a break adjustment window 350, to yield an interval-range 355.

According to some embodiments of the present disclosure, the schedule-adjustment module 310 may operate a forecast analyzer 370 which may receive a number of required agents in the calculated interval range 360 and the number of scheduled agents in the interval range 365.

According to some embodiments of the present disclosure, the interval range may be calculated to bound the schedule adjustments to avoid violating any work rules. The work rules may be stored in the RDBMS and may be based on work rule definitions. For example, the first break of an agent should be between 3-5 hours of the shift start, and the second break should be at least 2 hours away from first break. Similar rules may be defined for other unavailability-interval type activities like lunch etc.

According to some embodiments of the present disclosure, the forecast analyzer 370 may find staffing gaps between scheduled staff 365 and required staff 360, based on the staffing gaps it may mark intervals which are overstaffed or understaffed. A maximum overstaffed interval from all the overstaffed intervals may be selected 375 to move the unavailability-interval type to it within the interval range 380 to normalize the forecast by removing agent break from current interval to the overstaffed interval, e.g., adjust schedule 385. This may increase the occupancy and optimize the unavailability-interval type position while maintaining the work rule policy.

According to some embodiments of the present disclosure, when a maximum interval is found, the schedule-adjustment module 310 may include adjusting the agent schedule 385 and notifying the agent 390 as to the schedule adjustment. If there is no best fit interval, then the agent may be notified to go to next activity of 11:30 as shown in element 395 as soon as possible to avoid an adherence violation and the schedule-adjustment module 310 may adjust the agent-schedule based on the new agent state if it is within the define range. The schedule adjustment range may be calculated to consider any work rules or Human Resource (HR) rules violations.

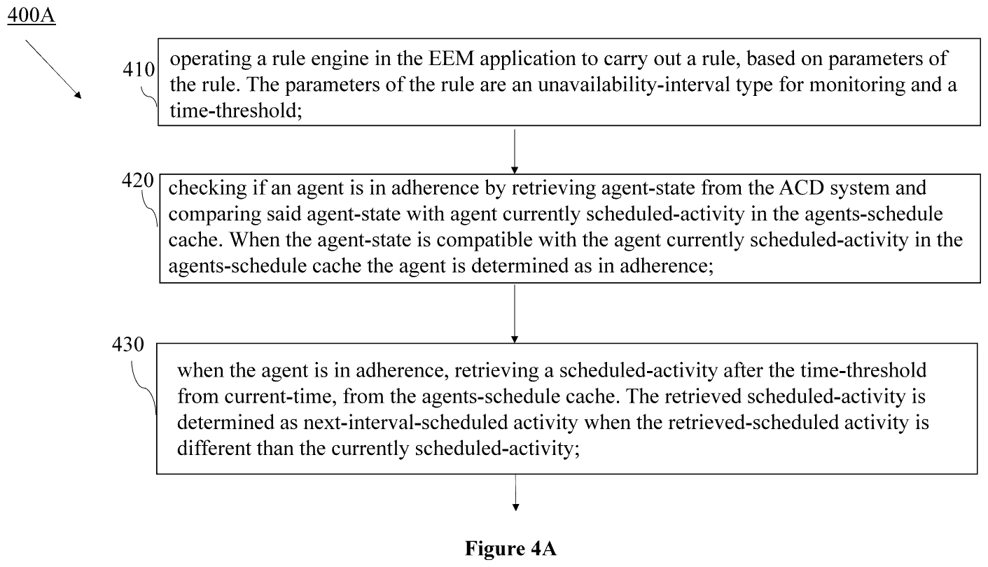

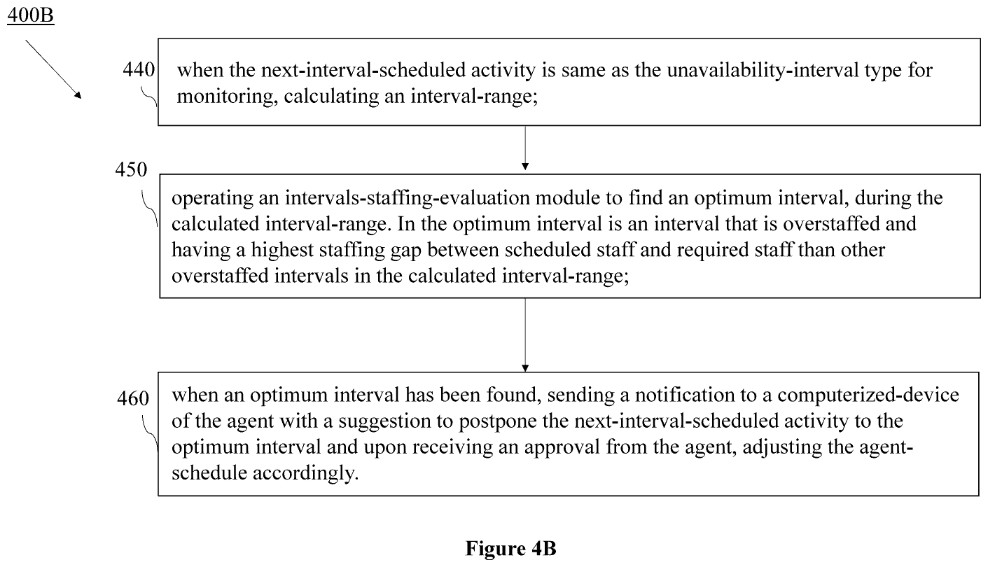

FIGS. 4A-4B are a high-level workflow of a schedule-adjustment module 400, in accordance with some embodiments of the present disclosure.

According to some embodiments of the present disclosure, operation 410 comprising operating a rule engine in the EEM application to carry out a rule, based on parameters of the rule. The parameters of the rule are an unavailability-interval type for monitoring and a time-threshold. The parameters of the rule may be configured via a GUI that may be associated to the EEM application, as shown in screenshots 500A-500B in FIGS. 5A-5B. The EEM application may be an application, such as EEM application 160 in FIG. 1 and the rule engine may be an engine, such as rule engine 125.

According to some embodiments of the present disclosure, operation 420 comprising checking if an agent is in adherence by retrieving agent-state from the ACD system and comparing said agent-state with agent currently scheduled-activity in the agents-schedule cache. When the agent-state is compatible with the agent currently scheduled-activity in the agents-schedule cache the agent is determined as in adherence. The ACD system may be a system, such as ACD 115 in FIG. 1 and the agents-schedule cache may be a cache, such as agents-schedule cache 105.

According to some embodiments of the present disclosure, operation 430 comprising when the agent is in adherence, retrieving a scheduled-activity after the time-threshold from current-time, from the agents-schedule cache. The retrieved scheduled-activity is determined as next-interval-scheduled activity when the retrieved-scheduled activity is different than the currently scheduled-activity.

According to some embodiments of the present disclosure, operation 440 comprising when the next-interval-scheduled activity is same as the unavailability-interval type for monitoring, calculating an interval-range.

According to some embodiments of the present disclosure, operation 450 comprising operating an intervals-staffing-evaluation module to find an optimum interval, during the calculated interval-range. In the optimum interval is an interval that is overstaffed and having a highest staffing gap between scheduled staff and required staff than other overstaffed intervals in the calculated interval-range. The intervals-staffing-evaluation module may be a module such as intervals-staffing-evaluation module 165 in FIG. 1.

According to some embodiments of the present disclosure, operation 460 comprising when an optimum interval has been found, sending a notification to a computerized-device of the agent with a suggestion to postpone the next-interval-scheduled activity to the optimum interval and upon receiving an approval from the agent, adjusting the agent-schedule accordingly. The notification may be sent by a notification service 130 in FIG. 1.

FIG. 5A is a screenshot depicting a user interface 500A to configure monitoring an unavailability-interval type to adjust agent-schedule to be in adherence and to balance workforce, in accordance with some embodiments of the present disclosure.

According to some embodiments of the present disclosure, a rule may be created in an engine, such as rule engine 125 in FIG. 1. The rule object which is adaptive event may be configured with set parameters as shown in screenshot 500B in FIG. 5B.

FIG. 5B is a screenshot depicting a user interface 500B to configure monitoring an unavailability-interval type to adjust agent-schedule to be in adherence and to balance workforce, in accordance with some embodiments of the present disclosure.

According to some embodiments of the present disclosure, activities e.g., unavailability-interval types may be selected for monitoring and a threshold time. All the activities which are defined in system may be listed, among which user may select multiple activities for adherence monitoring and schedule adjustments.

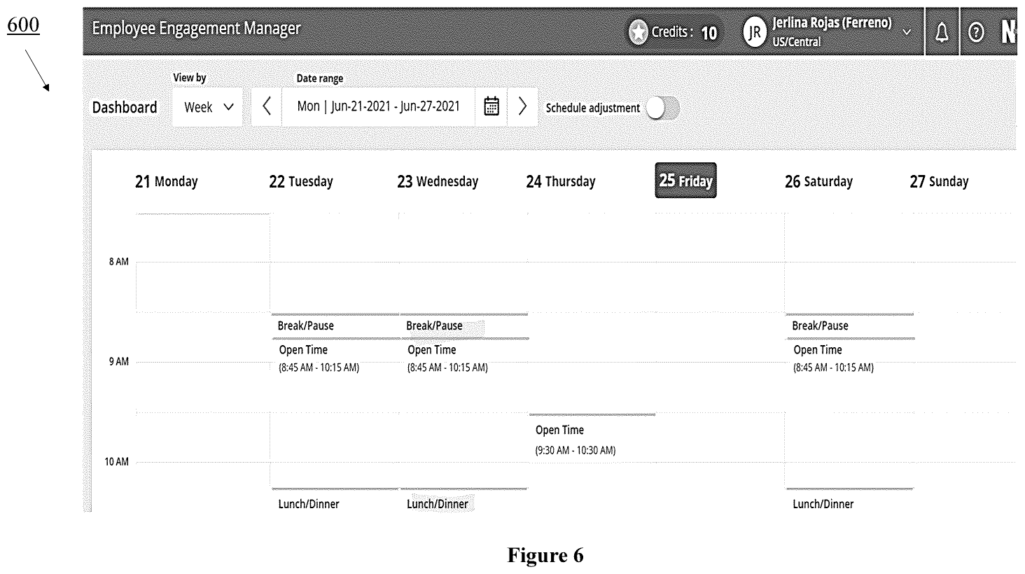

FIG. 6. is a screenshot of agent schedule in EEM application 600, in accordance with some embodiments of the present disclosure.

According to some embodiments of the present disclosure, an agent schedule may be presented via a Graphical User Interface (GUI) of an EEM application, such as EEM application 160 in FIG. 1.

According to some embodiments of the present disclosure, the presented agent schedule as shown in screenshot 600 may be an agent schedule throughout a week.

FIG. 7A is a screenshot 700A depicting a notification to an agent with a suggestion to precede the next-interval-scheduled activity to current-time, in accordance with some embodiments of the present disclosure.

According to some embodiments of the present disclosure, for example, a situation that may trigger the schedule notification 700A may be when there was no optimal interval identified based on the work rules before the next activity, thus a notification may be sent to agent about their next activity, to alarm them to start it on time to avoid the status of out of adherence.

FIG. 7B is a screenshot 700B depicting a notification to an agent with a suggestion to precede the next-interval-scheduled activity to current-time, in accordance with some embodiments of the present disclosure.

According to some embodiments of the present disclosure, for example, a situation that may trigger the schedule notification 700B may be when there was no optimal interval identified based on the work rules post agent current activity became out of adherence, thus a notification may be sent to the agent to start next activity as soon as possible and the system, such as system 100 in FIG. 1 may adjust the schedule to avoid manual request for rectifying out of adherence flag.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for monitoring unavailability-interval type to adjust agent-schedule to be in adherence and to balance workforce, in a contact-center, the computerized-method comprising:
in a computerized system comprising: one or more processors, Automatic Call Distribution (ACD) system, an agents-schedule cache, and Employee Engagement Manager (EEM) application, the one or more processors are configured to operate a schedule-adjustment module, said schedule-adjustment module comprising:
a. operating a rule engine in the EEM application to carry out a rule, based on parameters of the rule, wherein the parameters of the rule are an unavailability-interval type for monitoring and a time-threshold;
for each agent in the agents-schedule cache:
b. checking if the agent is in adherence by retrieving agent-state from the ACD system and comparing said agent-state with agent currently scheduled-activity in the agents-schedule cache,
wherein when the agent-state is compatible with the agent currently scheduled-activity in the agents-schedule cache the agent is determined as in adherence,
c. when the agent is in adherence, retrieving a scheduled-activity after the time-threshold from current-time, from the agents-schedule cache,
wherein the retrieved scheduled-activity is determined as next-interval-scheduled activity when the retrieved-scheduled activity is different than the currently scheduled-activity;
d. when the next-interval-scheduled activity is same as the unavailability-interval type for monitoring, calculating an interval-range;
e. operating an intervals-staffing-evaluation module to find an optimum interval, during the calculated interval-range,
wherein the optimum interval is an interval that is overstaffed and having a highest staffing gap between scheduled staff and required staff than other overstaffed intervals in the calculated interval-range; and
f. when an optimum interval has been found, sending a notification to a computerized-device of the agent with a suggestion to postpone the next-interval-scheduled activity to the optimum interval and upon receiving an approval from the agent, adjusting the agent-schedule accordingly.

2. The computerized-method of claim 1, wherein schedules of each agent in the agents-schedule cache are synchronized every preconfigured interval with a Workforce Management (WFM) system.

3. The computerized-method of claim 1, wherein the unavailability-interval is selected from at least one of: break, lunch, meeting, coaching, back office or any other activity.

4. The computerized-method of claim 1, wherein the calculating of the interval range is based on work-rules related to the unavailability-interval type.

5. The computerized-method of claim 1, wherein the adjusting of the agent-schedule is operated by updating the agent-schedule in the agents-schedule cache with the next-interval-scheduled activity in the optimum interval.

6. The computerized-method of claim 1, when no optimum interval has been found then sending a notification to a computerized-device of the agent with a suggestion to conclude current activity within a predefined threshold and to precede the next-interval-scheduled activity to current-time and upon receiving an approval from the agent, adjusting the agent-schedule based on the time that the agent moved to the next-interval-scheduled activity.

7. The computerized-method of claim 6, wherein the adjusting of the agent-schedule is operated by updating the agent-schedule in the agents-schedule cache with the next-interval-scheduled activity starting in the current-time.

8. The computerized-method of claim 1, when the agent is not in adherence-state and the agent-state is on-call and the agent currently scheduled-activity in the agents-schedule cache is an unavailability-interval type automatically adjusting the agent schedule.

9. The computerized-method of claim 8, wherein the adjusting of the agent-schedule is operated by updating the agent-schedule in the agents-schedule cache when agent-state from the ACD system changes accordingly.

10. The computerized-method of claim 1, wherein after the adjusting of the agent-schedule sending a notification to the computerized-device of the agent as to the schedule adjustment.

11. A computerized-system for monitoring unavailability-interval type to adjust agent-schedule to be in adherence and to balance workforce, in a contact-center, the computerized-system comprising:
one or more processors;
Automatic Call Distribution (ACD) system;
an agents-schedule cache; and
Employee Engagement Manager (EEM) application,
the one or more processors are configured to operate a schedule-adjustment module, said schedule-adjustment module is configured to:
a. operate a rule engine in the EEM application to carry out a rule, based on parameters of the rule, wherein the parameters of the rule are an unavailability-interval type for monitoring and a time-threshold;
for each agent in the agents-schedule cache:
b. check if the agent is in adherence by retrieving agent-state from the ACD system and comparing said agent-state with agent currently scheduled-activity in the agents-schedule cache,
wherein when the agent-state is compatible with the agent currently scheduled-activity in the agents-schedule cache the agent is determined as in adherence,
c. when the agent is in adherence, retrieve a scheduled-activity after the time-threshold from current-time, from the agents-schedule cache,
wherein the retrieved scheduled-activity is determined as next-interval-scheduled activity when the retrieved-scheduled activity is different than the currently scheduled-activity;
d. when the next-interval-scheduled activity is same as the unavailability-interval type for monitoring, calculate an interval-range;
e. operate an intervals-staffing-evaluation module to find an optimum interval, during the calculated interval-range,
wherein the optimum interval is an interval that is overstaffed and having a highest staffing gap between scheduled staff and required staff than other overstaffed intervals in the calculated interval-range; and
f. when an optimum interval has been found, send a notification to a computerized-device of the agent with a suggestion to postpone the next-interval-scheduled activity to the optimum interval and upon receiving an approval from the agent, adjust the agent-schedule.
